(19) United States
(12) Patent Application Publication
(10) Pub. No.: US 2003/0011095 A1
(43) Pub. Date: Jan. 16, 2003

(54) Method for fabricating imitative stone furniture

(76) Inventor: Lausan Chung-Hsin Liu, Hsin-Tien City (TW)

Correspondence Address: BACON & THOMAS, PLLC, 625 SLATERS LANE, FOURTH FLOOR, ALEXANDRIA, VA, 22314

(21) Appl. No.: 09/903,556

(22) Filed: Jul. 13, 2001

(51) Int. Cl. B29C 39/10

(52) U.S. Cl. 264/129; 264/259

(57) ABSTRACT

A method for fabricating imitative stone furniture mainly utilizes non-stone raw materials to fabricate and form substrates of various shapes desired, then evenly cover the surfaces of the substrates with a coating material, then dry and cure the coating material until the coating material solidified to form an imitative stone layer on the surfaces of the substrates. The resulting substrates may be used to fabricate various types of furniture such as tables and chairs.

### BACKGROUND OF THE INVENTION

The present invention relates to a method for fabricating imitative stone furniture that utilizes non-stone material to make substrates and covers the surfaces of the substrates with a coating material and curing the coating material to form an imitative stone layer on the surfaces of the substrates thereby to make furniture such as tables and chairs that are light weight, easy to fabricate and versatile to shape in various forms.

The commonly used table tops these days are mostly made of stone, woods, plywood, or dense laminates made by compressing wooden powder. The table tops made of stone generally give people better visual and touch feeling, and as a result, have better aesthetic appealing and greater value. However, the stone table tops also have disadvantages, such as follows:

1. Raw material of the stone is difficult to acquire and is more expensive. The furniture made of pure stone (such as marble) are too expensive for most consumers. Hence stone furniture generally are used in limited and selected locations. They are not widely available.

2. Stone furniture are quite heavy. Once being set at a location, they usually remain stationary for a long period of time. To move or change the locations often involves a lot of transportation problems, and requires a lot of manpower and moving equipment. In order to support the heavy stone table tops, the leg pedestals also have to be made of stone. As a result, the total weight and costs become even greater.

3. The stone generally has a greater hardness. It cannot be trimmed, cut or assembled by using screws or rivets like furniture made of other materials. Hence the stone furniture are generally shaped in round or square. Because of their difficulty for fabrication such as drilling, the stone furniture mostly are located indoors. Their applicability is limited.

### SUMMARY OF THE INVENTION

In view of aforesaid disadvantages, it is therefore an object of the present invention to provide a method that utilizes non-stone material to fabricate and form substrates, coats the substrates with a layer of coating material, and cures and solidifies the coating material to form an imitative stone layer on the substrates. The finished substrates are light weight, easy to fabricate and versatile to shape for making furniture such as tables and chairs. Besides having the advantages of light weight, easier to acquire material, and lower prices, the finished substrates also are easier to carve and sculpture, thus may be designed and made in various elegant forms. The imitative stone layer and raw material have a lower hardness. The table tops being made may be assembled directly and easily to the leg pedestals. Apertures may be formed thereon to hold parasols. Thus the furniture made of the imitative stone material of the invention can be used indoors and outdoors equally well. As a result, the invention has greater economic value.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a fabrication flow of the invention.

FIG. 2 is a fragmentary sectional view of a first embodiment of the invention.

FIG. 3 is a fragmentary sectional view of a second embodiment of the invention.

FIG. 4 is a fragmentary sectional view of a third embodiment of the invention.

FIG. 5 is a schematic view of an embodiment of the invention.

FIG. 6 is a schematic view of another embodiment of the invention.

### DESCRIPTION OF THE PREFERRED EMBODIMENTS

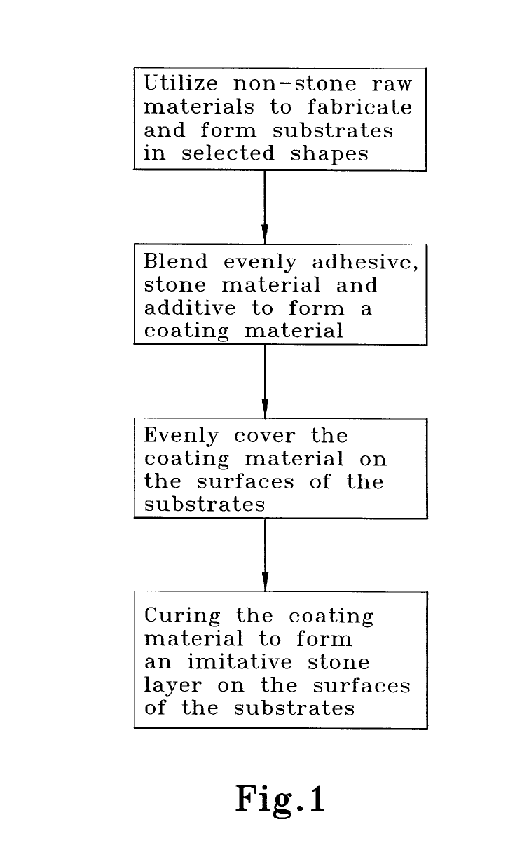

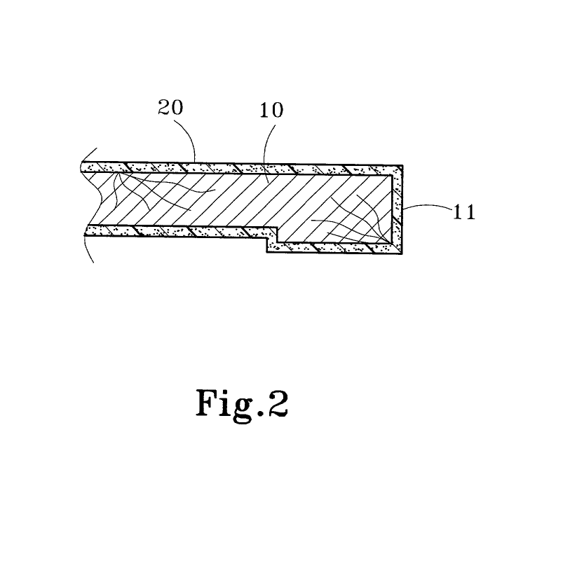

Referring to FIGS. 1 and 2, the method of the present invention utilizes non-stone materials for raw materials. The raw materials could be wooden products such as plywood, laminated wooden boards, dense compression boards made of wooden powder and the like that have lower hardness, or plastics, fiber plates, etc. As the raw materials have lower hardness, they are easier to process by cutting, compression and injection molding to form various shapes of substrates 10. When the substrates 10 are made and formed, use a spray gun (not shown in the drawings) to spray and cover a coating material on the surfaces of the substrates 10. The spraying of coating material may be done at a speed about one square meter per five minutes. The coating material includes adhesive, stone material and additive. The adhesive may include water-based resins or thermosetting resins. The stone material may include stone wastes resulting from stone cutting work, such as stone powder, stone debris, stone flakes, or gravel. The additive may include pigments for enhancing the stone imitative effect or drying catalysts for accelerating the drying speed of the coating material. The blending ratio of aforesaid materials may be ranged from 30% to 70% for the adhesive by weight, and 30% to 70% for the stone material, and 0.5% to 1% for the additive. The blending ratio of the adhesive and stone material is preferably 1:1. When the surfaces of the substrates 10 are completely covered by the coating material, a curing process will be performed for about 20 to 30 hours to solidify the coating material. The solidified coating material forms an imitative stone layer 20 on the surfaces of the substrates 10. As a result, the non-stone substrates 10 have the appearance of stone.

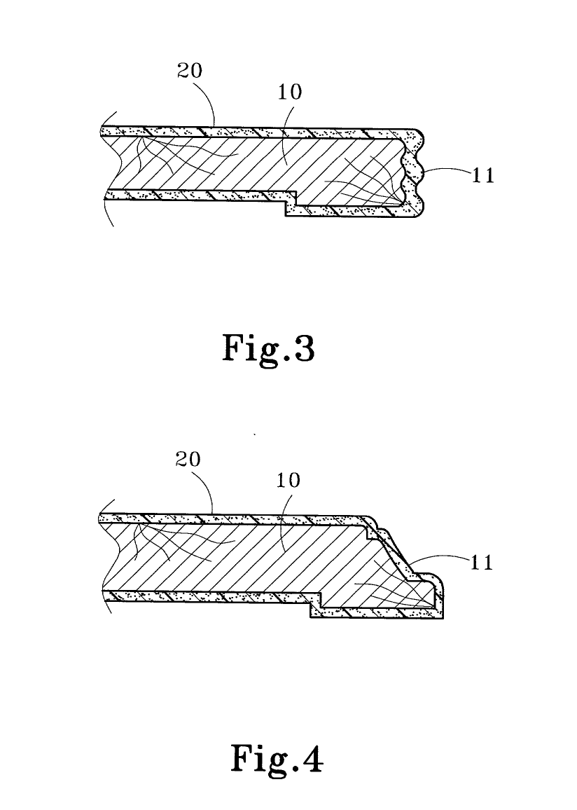

By means of the invention, the coating material covered the substrates 10 will solidify to form the imitative stone layer 20, hence the imitative stone layer 20 may be shaped in various forms according to the designed shapes of the substrates 10. FIG. 2 shows a design for a table top which has the rim 11 formed with simple straight lines normal to each other. FIGS. 3 and 4 illustrate more examples for table tops made of the substrates 10 with the rims 11 formed in various shapes such as a single curve or multi-curve fashion, or stepwise and cascaded fashion. The design patterns may also be formed on the bottom side of the substrate 10. After coating with the imitative stone layer 20 and solidified, the finished products have greater aesthetic appealing.

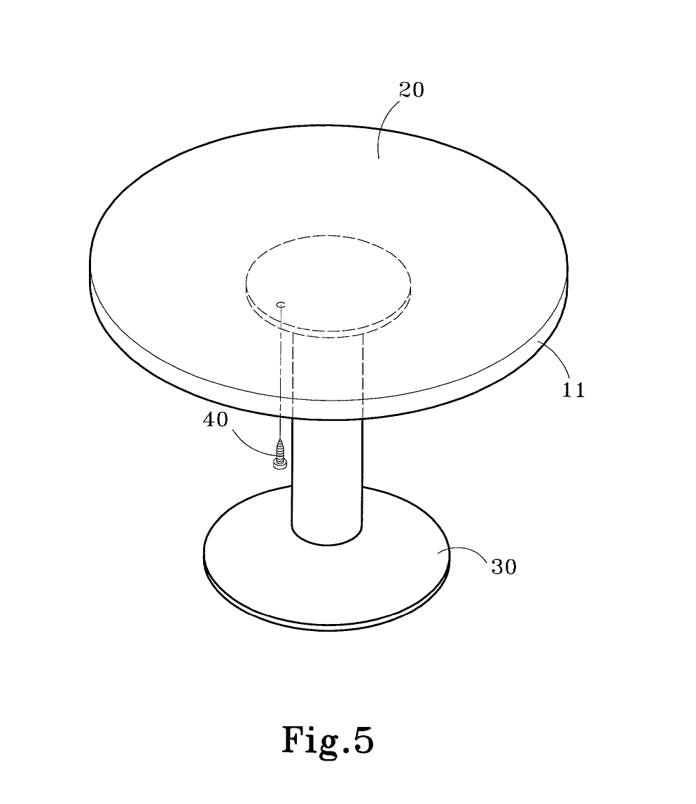

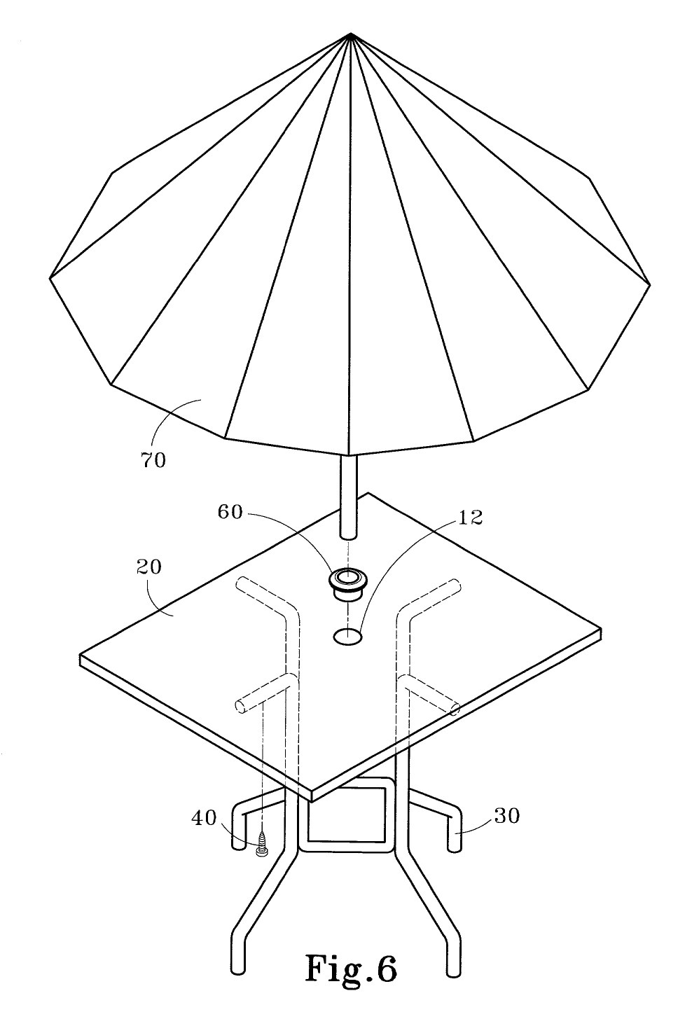

Referring to FIGS. 5 and 6, because the substrate 10 and imitative stone layer 20 have lower hardness, they can be fabricated to form table top, and table leg pedestal 30 may be directly fastened to the inner side of the substrate 10 through fasteners 40 to form a table. Furthermore, an aperture 12 may be formed on the substrate 10 to house a protective sleeve 60 for receiving a parasol 70, thereby to form a leisure table outfit for outdoors use.

In summary, the present invention utilizes non-stone raw materials that have lower hardness, lighter weight and lower prices to fabricate and form versatile substrates 10. Then evenly cover the substrate surfaces with a blended coating material which has density proximate to the real stone. After curing process, the coating material solidifies to form an imitative stone layer 20 on the substrate surfaces. The resulting goods are much lower in prices, and have lighter weight and lower hardness. The carving property of the material is good and may be shaped in various forms desired. The goods have substantially same visual and touch effect as the real stone. The raw materials may be acquired from wastes that are easy to fabricate and process. Thus the invention offers great economic value and can effectively overcome the shortcomings incurred to the conventional stone-made furniture.

While the preferred embodiments of the invention have been set forth for the purpose of disclosure, modifications of the disclosed embodiments of the invention as well as other embodiment thereof may occur to those skilled in the art. Accordingly, the appended claims are intended to cover all embodiments which do not depart from the spirit and scope of the invention.

What is claimed is:

1. A method for fabricating imitative stone furniture utilizing non-stone materials to make imitative stone furniture, comprising the steps of:
a. fabricating and forming non-stone raw materials to become substrates of selected shapes;
b. blending adhesive, stone material and additive according to a selected ratio to form a coating material;
c. covering evenly the coating material on the surfaces of the substrates; and
d. drying and curing the coating material until the coating material solidified to form an imitative stone layer on the surfaces of the substrates.

2. The method of claim 1, wherein the raw materials for the substrates include plywood, laminated wooden board, and dense compression board made of wooden powder.

3. The method of claim 1, wherein the raw materials for the substrates include plastics and fiber plates.

4. The method of claim 1, wherein the fabricating and forming include selectively cutting, compression and injection molding based on the raw materials.

5. The method of claim 1, wherein forming the coating material is done by blending the adhesive in the range of 30% to 70% by weight, the stone material in the range of 30% to 70% by weight, and the additive in the range of 0.5% to 1% by weight, and the best ratio for blending the adhesive and the stone is 1:1.

6. The method of claim 1, wherein the adhesive is a water-based resin.

7. The method of claim 1, wherein the stone material includes stone powder, stone debris, stone flakes, and gravel.

8. The method of claim 1, wherein the additive includes pigments for enhancing stone imitative effect.

9. The method of claim 1, wherein the additive includes a drying catalyst for accelerating drying and curing speed of the coating material.

10. The method of claim 1, wherein curing time in the step of the drying and curing the coating material is ranged from twenty hours to thirty hours.
